(19) United States
(12) Patent Application Publication
(10) Pub. No.: US 2008/0219563 A1
(43) Pub. Date: Sep. 11, 2008

(54) CONFIGURATION OF A PLURALITY OF IMAGES FOR MULTI-DIMENSIONAL DISPLAY

(76) Inventor: Nathan M. Moroney, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/682,899

(22) Filed: Mar. 7, 2007

(51) Int. Cl. G06K 9/62; G06K 9/68

(52) U.S. Cl. 382/224; 382/218

(57) ABSTRACT

Configuration of a plurality of images for multi-dimensional display includes taking a multi-dimensional layout of the images, and analyzing different sets of locations in the layout. The analysis of each set includes determining whether swapping images at the set of locations would increase local similarity in the set.

### BACKGROUND

File managers configure and display a collection of icons and thumbnails in a linear order. These images are typically configured alphabetically or according to some other feature such as time stamp or author. For instance, the images are configured in one or more rows, progressing alphabetically in a linear order from left to right and top to bottom.

Search engines also display thumbnails in a linear order. A search of images is performed, a collection of thumbnails is returned, and the thumbnails are displayed in a particular order (or no discernable order).

A person viewing a collection of images might want those images configured according to multiple features to help explore, navigate through, and analyze those images. A linear ordering of those images might not be satisfactory.

### SUMMARY

According to one aspect of the present invention, configuration of a plurality of images for multi-dimensional display includes taking a multi-dimensional layout of the images, and analyzing different sets of locations in the layout. The analysis of each set includes determining whether swapping images at the set of locations would increase local similarity in the set.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a method of configuring a set of images in accordance with an embodiment of the present invention.

FIGS. 2a-2c are illustrations of a portion of an image layout.

FIG. 3 is an illustration of a method of selecting locations to analyze in accordance with an embodiment of the present invention.

FIG. 4 is an illustration of a method of determining whether swapping images at a pair of locations would increase local similarity in the pair.

FIG. 5 is an illustration of a machine in accordance with an embodiment of the present invention.

### DETAILED DESCRIPTION

As shown in the drawings for purposes of illustration, the present invention is embodied in the configuration of a plurality of images for multi-dimensional display. The images are configured according to certain features (“configuration features”). Consider a simple example in which the configuration features include (1) the number of faces detected in an image; and (2) the need for red eye correction. After configuration, images having similar features are clustered together. Images in which faces are not detected are clustered in a first region of a layout, images needing red eye correction are clustered in a second region, and images not needing red eye correction are clustered in a third region. The clustering is especially valuable if the number of configuration features is greater than the dimensionality of the display (e.g., the images are configured according to four features, whereas the display is two-dimensional).

The clustering is achieved by analyzing “local similarity” in sets of locations. Local similarity refers to how similar an image is to its neighboring (local) images with respect to configuration features.

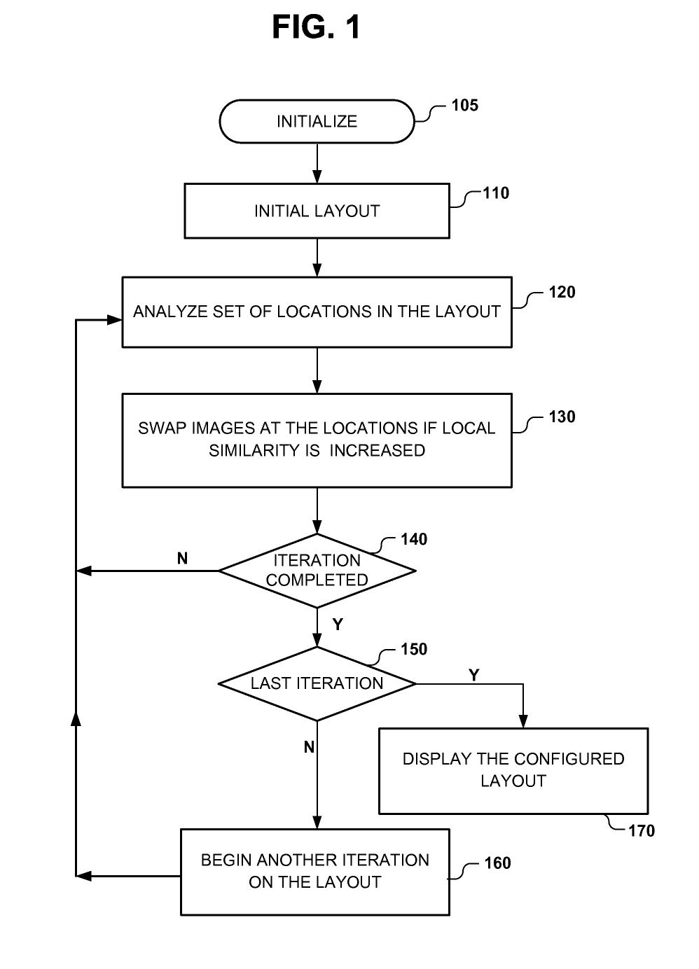

Reference is now made to FIG. 1, which illustrates an exemplary method of configuring a plurality of images for multi-dimensional display. At block 110, an initial multi-dimensional layout of the images is taken (e.g., accessed, made). The initial layout could be a pseudo-random configuration of the images, or it could be an ordered configuration (e.g., ordered alphabetically, by time stamp). The different images in the initial layout could have the same size, aspect ratio, geometry (e.g., square, rectangular, triangular, hexagonal, a distorted geometry), or they could have different sizes, different aspect ratios, different geometries, etc. The initial layout could be two-dimensional or higher.

The source of the images is not limited to any particular type. For example, the images could be acquired or stored on a portable media player, digital camera, camera phone, laptop or other computing device. The images could be digital photographs, computer graphics, frames extracted from video sequences, or medical or other images derived through other imaging modalities. The images could be collections of consumer images, collections of images stored in a centralized database of images, collections of professional images or other image collections.

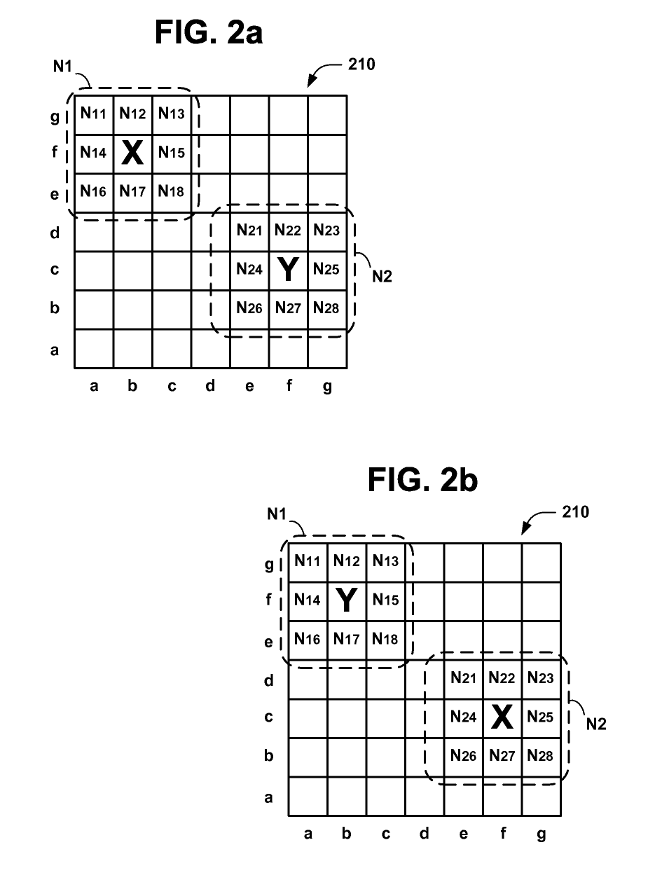

Additional reference is made to FIG. 2a, which illustrates an example of an initial two-dimensional layout 210. In this exemplary layout 210, the images are arranged in a grid. Locations on the grid are denoted by a pair of coordinates. Each location contains an image. For example, image X is located at coordinates [b,f], and image Y is located at coordinates [f,c].

At block 120, a set of locations in the initial layout is analyzed. In some embodiments, the set may include a pair of locations. In other embodiments, a set may include more than two locations. The analysis of the set includes determining whether swapping images at the locations would increase local similarity (or reduce local dissimilarity) in the set. The local similarity of an image may be determined by comparing configuration features of the image to those of its neighboring images.

In the exemplary layout of FIG. 2a, consider the analysis of locations [b,f] and [f,c]. Local similarity is determined for image X with respect to its neighboring images N11-N18. Local similarity is also determined for image Y with respect to its neighboring images N21-N28. Let D11 represent a measure of local similarity of image X with respect to its neighboring images N11 -N18, and let D22 represent a measure of local similarity of the image Y with respect to its neighboring images N21-N28.

The 3×3 neighborhoods N1 and N2 in FIG. 2a are merely exemplary. Other localities may be used (e.g., 5×5 neighborhoods, circular neighborhoods).

Additional reference is now made to FIG. 2b. Now consider the local similarity if the images X and Y are swapped. Local similarity of image X is considered at location [f,c], and local similarity of image Y is considered at location [b,f]. Let D12 represent a measure of local similarity of the image X with respect to its neighboring images N21-N28, and let D21 represent a measure of local similarity of the image Y with respect to its neighboring images N11-N18.

At block 130, the images are swapped if the local similarity in the set is increased. In some embodiments, the local similarity is increased only if the local similarity at each location is increased by a swap. Using the example of FIG. 2b, if image X's configuration features are more similar to those of the images N21-N28, and if image Y's configuration features are more similar to those of the images N11-N18, then the images X and Y are swapped. Thus, image X will be moved to location [f,c], and image Y will be moved to location [b,f]. If local similarity is not increased at both locations [b,f] and [f,c] by swapping the images X and Y, then the images X and Y are not swapped.

In other embodiments, the local similarity could be increased if the net local similarity is increased. That is, the images are swapped if(D12+D21)<(D11+D22).

Other sets of locations are analyzed (block 120), and other swaps are performed (block 130) until a first iteration of the layout has been completed (block 140). At the end of the first iteration, all possible sets of locations might have been analyzed. In the alternative, only a subset of the possible sets might have been analyzed to ease processing requirements. This aspect will be discussed below.

Each analysis of a location set is performed on an updated layout. For example, if the images X and Y were swapped, as shown in Figure 2c, and the next analysis is performed on locations [b,f] and [e,c], then the images being analyzed will be images Y and Z. Image X will be part of the neighborhood N2.

The configuration features are not limited to any particular types. Examples of visual features include, but are not limited to color components (e.g., red value, green value, blue value, luminance, saturation, hue), occurrence of objects in an image (e.g., presence of faces), certain types of defects in an image (e.g., red eye, color artifacts), symmetry (horizontal symmetry, vertical symmetry), etc. Measures of the visual features could be measurements of color components an image (e.g., digital count of average red in an image, maximum or minimum value of luminance), number or likelihood of certain objects in an image occurrence (e.g., number of faces), certain conditions (e.g., detection of red eye), scene type classification, face recognition analysis, aspect ratio, resolution, noise levels, overall image contrast and other image attributes. The visual features can be obtained directly from the image, for example, by red-eye detector, face detector, shape detector, pixel values, etc.

The configuration features may include non-visual features as well as visual features. Examples of non-visual features include, but are not limited to, file properties, file metadata, editing or printing history, date annotations or chronological information, geographic annotations, global positioning system data, audio annotations, voice annotations, and other data associated with image files. The non-visual features could be obtained for example, from file properties, file metadata, tags, etc. The non-visual features could be derived from any associated telecommunications network, such as phone number, from any associated search engine, such as relative ranking or closely related uniform resource locators, from the specific imaging application, such as usage and history information, from the operating system, such as image usage in other applications, or other context specific manner.

The local similarity at a location can be computed as a combination of the differences between an image and each of its neighbors. The difference for each feature could be expressed in terms of a sum of differences, root mean square, or a difference with the mean, median, local maximum or local minimum, or some other measure. The measure of local similarity is then determined by combining the differences. The differences could be combined by taking an average of the differences, by computing the Euclidean distance, or some other measure.

Certain configuration features might be more important than others. The measure of each feature may be weighted to reflect their relative importance.

For example, each image in a layout is described by the following vector: [no. of faces detected, mean luminance, year]. Now consider the values in Table 1 for the neighborhood N1 in FIG. 2a. The reference image is the image at location [b,f], which has the vector [0,112,2005]. A difference value D_{NO}, D_{Y} and D_{YR} is computed for each component. If the local similarity is expressed as a difference from the maximum, the difference values are D_{NO}=(4-0), D_{Y}=(112-200), and D_{YR}=(2005-2007). The measure of local similarity can be computed as follows:

D11=sqrt(a D_{NO}²+b D_{Y}²+c D_{YR}²).

where a, b and c are weights. In some instances the configuration features can be normalized to a common range. For example, the range can be between 0 and 1, where 0 is for the minimum value or first instance and 1 is the maximum value or last instance.

TABLE 1

| Location | No. of faces | Mean Luminance | Year |
|---|---|---|---|
| [a, g] | 2 | 100 | 2007 |
| [b, g] | 1 | 200 | 2003 |
| [c, g] | 1 | 110 | 2002 |
| [a, f] | 1 | 86 | 2003 |
| [b, f] | 0 | 112 | 2005 |
| [c, f] | 0 | 114 | 2001 |
| [a, e] | 1 | 192 | 2000 |
| [b, e] | 4 | 156 | 1990 |
| [c, e] | 2 | 100 | 2002 |

Additional iterations are performed on the layout until an exit criteria is reached (block 150). The exit criteria could be, for example, a maximum number of iterations or a threshold for mean differences.

For each additional iteration, analysis begins with a first pair of locations (block 160) and continues until the exit criteria is reached (block 150). The number of iterations could be scaled according to the amount of data that has to be processed. For example, the number of iterations could be 1-2 orders of magnitude more iterations than input thumbnails. In such an example, 2000 iterations might be performed on a layout of 20 images.

After the final iteration has been performed (block 150), the configured layout is displayed (block 170). In the displayed layout, images having similar configuration features will be clustered together in a non-linear manner. Visually similar images will be more intuitively located together and easier to locate in that similar images will be closer to each other. The clustering makes it easier to navigate through, explore and analyze the images in the layout.

The layout can describe many different configuration features, but in a lower dimensionality display. For example, 28 different features for a set of thumbnails could be described in a 2-D display.

The method can be applied to layouts having different boundary conditions and images having different sizes, shapes and aspect ratios. The method requires no prior knowledge of local sampling densities, input range, or any other clusters or categories.

Images having similar configuration features can be assigned to specific locations in the layout For example, black and white images can be assigned to the upper left quadrant, images in which faces are not detected can be assigned to the lower right quadrant. Such anchoring of features to certain regions in the layout can makes it easier to navigate through the configured images.

A method according to the present invention can be performed automatically, without user interaction. A self-configuring method can automatically analyze the images with respect to default configuration features. For example, a web browser downloads a set images, automatically configures the images according to default configuration features, and sends a layout to a display monitor.

In the alternative, a user can specify the configuration features. The configuration features could be specified during initialization (block 105). Anchor locations could also be specified during initialization.

Processing requirements for a method according to the present invention will depend upon a number of factors including, but not limited to, the number of images to be configured, the number of configuration features, the type of configuration features (for example, computing an average color component might be less intensive than performing face detection), time constraints (e.g., delays greater than x seconds might be impermissible). Another factor might include whether or not any data is missing so that additional analysis might be required. For example if some of the thumbnails have not previously had face detection applied, the face detection will be performed prior to configuring the images. Likewise if an image lacks a thumbnail, a thumbnail will be generated prior to configuring the images. The processing may also be dependent on image bit depth such that the processing precision is equivalent for all images.

Processing requirements can be eased by reducing the amount of data that has to be processed. As one example of reducing the amount of data, the images can be further downsampled. As another example, color values in the images can be quantized. On way of quantizing the color values is by lexical analysis. The lexical analysis involves assigning a limited set of names to colors in an image. The lexical analysis is disclosed in greater detail in assignee's U.S. Ser. No. 11/615,035 filed Dec. 22, 2006. The downsampling and quantization can reduce the colors to a workable (practical) number. The downsizing and quantization can be performed during initialization (block 105).

The configuration features could affect how the colors are quantized. For instance, text documents are likely to have fewer colors than natural images. As a result, colors in natural images might be quantized more aggressively than colors in text documents.

Data to be processed can also be reduced during analysis of location pairs (block 120). Instead of analyzing all possible sets of locations (e.g., all possible pairs involving location [a,a], all possible pairs involving locations [a,b], and so on), only a subset of the possible pairs is analyzed.

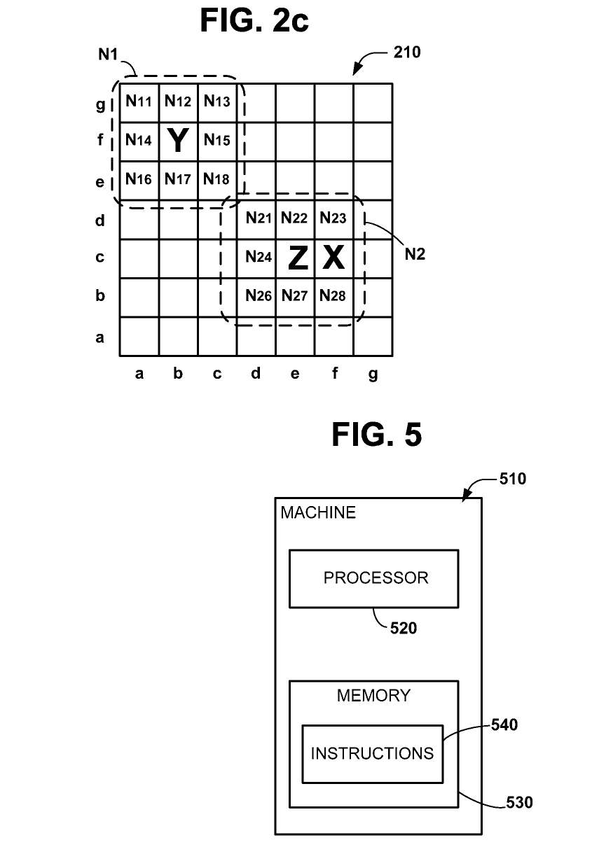

Reference is now made to FIG. 3, which illustrates an exemplary method of analyzing a subset of all possible locations. At block 310, a reference location is selected. At block 320, another location is selected at random. At blocks 330 and 340, the reference and random locations are analyzed, and images at those locations are swapped if local similarity at each of the locations is increased by the swap.

At block 350, another random location is selected. Or block 350 is skipped if only one random location is chosen for reach reference location. If another random location is selected (block 350), the reference and random locations are analyzed, and images at those locations are swapped if local similarity at each of the locations is increased by the swap (blocks 330-340).

After random locations have been selected (block 350), another reference location is selected (blocks 360 and 310). The next reference location may be selected at random, or it may be selected according to a predetermined order. For example, reference locations may be selected by starting with the first location in the layout and stepping sequentially to the last location in the layout. After a new reference location is selected, blocks 320-350 are repeated.

After all reference locations have been analyzed (block 360), the iteration is complete (block 370). Additional iterations may be performed on the layout.

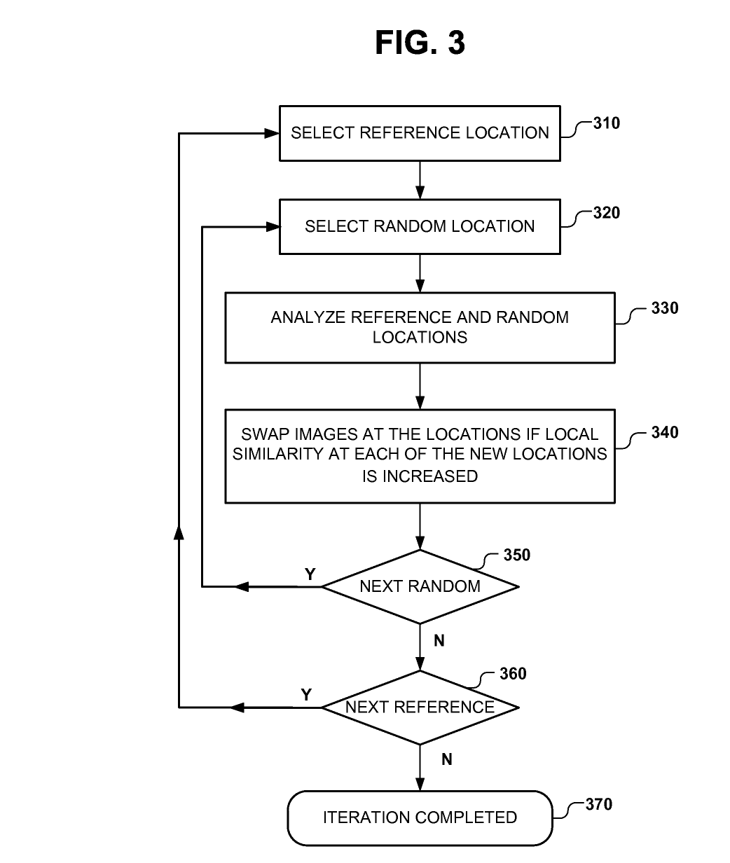

Reference is now made to FIG. 4, which illustrates an example of determining whether swapping images at a pair of locations would increase local similarity. At block 410, a reference location and a random location are selected.

At blocks 420-430, a local similarity measure D11 is computed for a reference image at a reference location, and a local similarity measure D22 is computed for a random image at a random location. At blocks 440-450, a local similarity measure D12 is computed for the reference image at the random location, and a local similarity measure D21 is computed for the random image at the reference location. Although blocks 420-450 are shown in a particular order, there is no particular order for computing the local similarity measures D11, D22, D12, and D21.

At block 460, it is determined whether local similarity would be increased by a swap. If the comparison of (D12+D21) to (D11+D22) indicates that net local similarity is increased by the swap, the swap is made (block 470) If the comparison indicates that net local similarity is not increased by the swap, the swap is not made (block 480).

A method according to the present invention is not limited to any particular software implementation. The method can be implemented as a standalone application, a plug-in to a web browser, etc. The method can be integrated with a search engine, image processing software (e.g., a photo editor), image display software (e.g., a photo album), file manager, or any other software that navigates through images. The method can be integrated with a virtualization tool that displays images in 3D or higher dimensionality. The method can be integrated with an operating system.

The method is not limited to any particular hardware implementation. The method could be used by any machine that can configure images. Example of such machines include, without limitation, computers (e.g., desktop, laptop, PDAs and other handheld), mobile phones, printers, portable media players, gaming consoles, video cameras and digital cameras. A machine according to the present invention could be a printer that reads images from memory, generates thumbnails of the images, and prints out the thumbnails. A machine with a screen could also configure a collection of images for sequential viewing of the images on that screen.

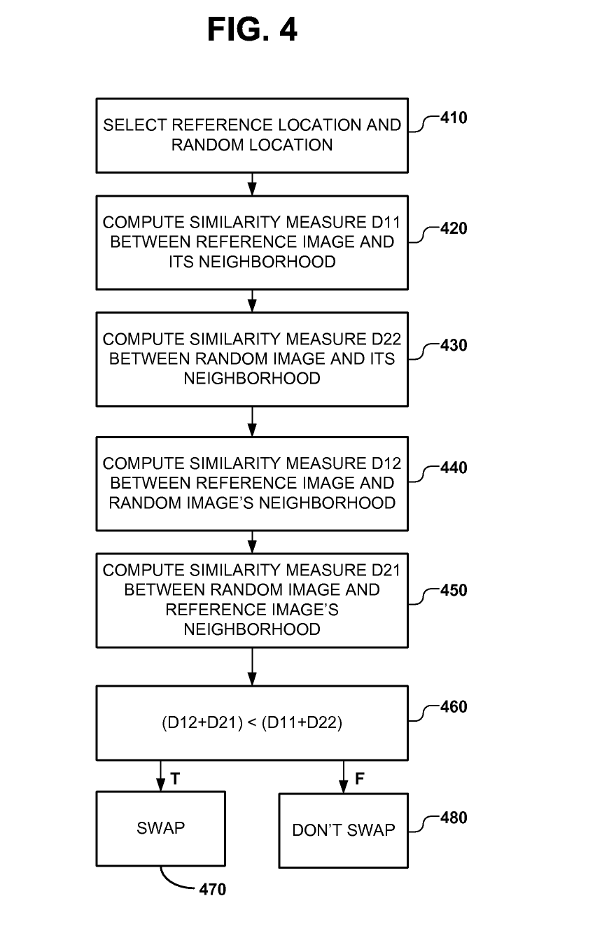

Reference is now made to FIG. 5, which illustrates a machine 510 having a processor 520 and memory 530. The memory 530 stores instructions 540 that, when executed, causes the processor 520 to configure a plurality of images in accordance with an embodiment of the present invention.

1. A method of configuring a plurality of images for multi-dimensional display, the method comprising:
taking a multi-dimensional layout of the images; and
analyzing different sets of locations in the layout, wherein the analysis of each set includes determining whether swapping images at the set of locations would increase local similarity in the set.

2. The method of claim 1, further comprising swapping images at a set of locations if the swapping increases the local similarity in that set.

3. The method of claim 2, wherein images at a set of locations are swapped only if local similarity at each location in that set is increased.

4. The method of claim 2, wherein images at a set of locations are swapped if net local similarity in the set is increased.

5. The method of claim 2, wherein each set includes a pair of locations, and wherein images are swapped a pair at a time.

6. The method of claim 2, wherein multiple iterations of the analysis and swapping are performed on the layout.

7. The method of claim 1, wherein the local similarity is based on features having a higher dimensionality than dimensionality of the layout.

8. The method of claim 1, wherein the local similarity is a function of visual configuration features.

9. The method of claim 1, further comprising assigning images having similar configuration features to specific regions of the layout.

10. The method of claim 1, wherein image data is reduced prior to analyzing the different sets of locations.

11. The method of claim 10, wherein the image data is reduced by analyzing a subset of all possible sets in the layout.

12. The method of claim 1, wherein determining whether swapping images would increase local similarity in a set includes:
computing a first local similarity measure for a reference image at a reference location, and a second local similarity measure for a random image at a random location;
computing a third local similarity measure for the reference image at the random location and a fourth local similarity measure for the random image at the reference location; and
performing a comparison with the first, second, third and fourth similarity measures.

13. A method comprising:
making a multi-dimensional layout of a plurality of images; and
performing multiple iterations of configuring the images in the layout, wherein each iteration includes swapping pairs of images, where the two images in a pair are swapped if each image in the pair is more similar to its new neighborhood than its old neighborhood, where the similarity is based on a number of configuration features, and where the number of configuration features is greater than the dimensionality of the layout;
whereby after the multiple iterations have been performed on the layout, images having similar configuration features are clustered together.

14. The method of claim 13, wherein the images at a pair of locations is also swapped if net similarity in the pair of locations is increased.

15. Apparatus comprising a processor for configuring a layout of images according to a plurality of configuration features, wherein the processor analyzes different sets of locations in the layout, and wherein the analysis of each set includes determining whether swapping images at the set of locations would increase local similarity in the set.

16. The apparatus of claim 15, wherein multiple iterations of configuring the images are performed, and wherein each iteration includes analyzing pairs of locations and swapping images in a pair if local similarity is reduced.

17. The apparatus of claim 15, wherein the number of configuration features is greater than dimensionality of the layout.

18. An article comprising memory encoded with instructions for causing a processor to configure a layout of images according to a plurality of configuration features, wherein different sets of locations in the layout are analyzed, and wherein the analysis of each set includes determining whether swapping images at the set of locations would increase local similarity in the set.

19. The article of claim 18, wherein the instructions cause the processor to perform multiple iterations of configuring the images, wherein each iteration includes analyzing pairs of locations and swapping images in a pair if local similarity is reduced.

20. The article of claim 18, wherein the number of configuration features is greater than dimensionality of the layout.
